(19) United States
(12) Patent Application Publication
(10) Pub. No.: US 2009/0072743 A1
(43) Pub. Date: Mar. 19, 2009

(54) ELECTRIC DISCHARGE LAMP

(75) Inventors: Mark Bolech, Eindhoven (NL); Gerald Frederik Belder, Eindhoven (NL); Bart Theresia Verlinden, Eindhoven (NL); Sigrid Maria Roman Gelderland, Eindhoven (NL); Martinus Joseph Maria Kessels, Eindhoven (NL); Andreas Sebastianus Gertrudis Geven, Eindhoven (NL); Antonius Cornelis Van Amstel, Eindhoven (NL); Cornelis Johannes Maria Denissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,742

(22) PCT Filed: Oct. 20, 2005
(86) PCT No.: PCT/IB05/53433

§ 371 Date: Apr. 23, 2007

(30) Foreign Application Priority Data
Oct. 25, 2004 (EP) 04105274.7

(51) Int. Cl. H01J 61/36

(52) U.S. Cl. 313/624

(57) ABSTRACT

An electric discharge lamp comprising: —a translucent ceramic lamp vessel; —a first and a second current conductor, each supporting an electrode in the lamp vessel; —an ionizable filling comprising a rare gas and metal halide in the lamp vessel; at least the first current conductor being halide-resistant, characterized in that the first current conductor forms an end cap of the lamp vessel, wherein said end cap is made of a metal selected from the group consisting of molybdenum, tungsten, iridium, rhodium, and rhenium, or an alloy thereof, and wherein said end cap is sealed onto the lamp vessel provided with a cermet layer comprising 10-60 vol. % molybdenum and 90-40 vol. % Al₂O₃.

The present invention relates to an electric discharge lamp comprising:

a translucent ceramic lamp vessel;

a first and a second current conductor, each supporting an electrode in the lamp vessel;

an ionizable filling comprising a rare gas and metal halide in the lamp vessel; at least the first current conductor being halide-resistant.

Such an electric lamp is known from EP-A-0 587 238. This known lamp is equipped with a ceramic sealing compound, and the ionizable filling comprises mercury. The current conductor of such a lamp must have a linear coefficient of thermal expansion which corresponds to that of the lamp vessel in order to prevent leakage of the lamp. Leakage may even occur in the manufacture of the lamp when the lamp cools down after the sealing compound has been provided at a relatively high temperature. Given a too low coefficient of expansion of the current conductor, the lamp vessel will shrink more strongly and may crack or even break. Given a too high coefficient of expansion, leakage may occur around the current conductors. However, the current conductors must also be resistant to the ionizable filling of the lamp, particularly to halide, at least in so far as they are in contact therewith: they should at least not substantially be attacked by or react with halide or halogen formed therefrom. A low resistance may not only result in damage and destruction of the current conductor, but also in a loss of halide in the filling and in a color change of the light generated by the lamp. Moreover, the current conductors must withstand the thermal manufacturing and operating conditions of the lamp and, to limit electrical losses, they should be good conductors. Since the requirements imposed on expansion and chemical resistance are often not combined in one material, at least the first current conductor of the known lamp has an inner halide-resistant part within the lamp vessel having a different expansion than the lamp vessel, and an outer part which extends from the seal, which is not halide-resistant, but which has a corresponding expansion. This part often consists of niobium, tantalum, or an alloy thereof, metals which, because of their oxidation sensitivity at higher temperatures, should be screened from air by means of an outer envelope of the lamp. If the lamp vessel is relatively narrow and elongate, and if it has a vertical operating position, the halogen formed from the halide is particularly present in the upper portion of the lamp vessel. It is then sufficient if only the first current conductor has an inner halide-resistant portion and is present in the upper portion of the lamp vessel. The lamp cannot be operated upside down, horizontally, or obliquely in that case. If a universal operating position is to be obtained, however, the lamp may be given a second current conductor similar to the first. The inner part of a current conductor of the known lamp generally comprises a molybdenum coil (foil?) or a cermet of molybdenum and aluminum oxide.

It is a drawback of the known lamp that the sealing compound sealing the ceramic lamp vessel around the current conductors is sensitive to high (operating) temperatures of the lamp. Therefore, it is necessary in the known lamp to apply the sealing compound as far away as possible from the central portion of the lamp vessel, i.e. at an outer end of extended plugs (i.e. elongate parts) that are connected by way of sintering to the central portion of the lamp vessel. Consequently, the construction of the known lamp is not as compact as would be desirable. Furthermore, the use of said extended plugs is undesirable from a technical point of view: said plugs function as cooling fins negatively influencing the efficacy of the lamp, and said extended plugs introduce capillaries into the lamp. Part of the lamp filling, particularly molten salts, may condense in a so-called dead volume in said extended plugs at the location of the capillaries, leading to color instability of the lamp. An excess quantity of such (expensive) salts needs to be dosed in the known lamp to compensate for the loss of part of the salts in said dead volume.

It is an object of the present invention to obviate these disadvantages. In order to accomplish that objective according to the invention, an electric lamp of the type referred to in the introduction is characterized in that the first current conductor forms an end cap of the lamp vessel, wherein said end cap is made of a metal selected from the group consisting of molybdenum, tungsten, iridium, rhodium, and rhenium, or an alloy thereof, and wherein said end cap is sealed onto the lamp vessel where the lamp vessel is equipped with a cermet layer comprising 10-60 vol. % molybdenum and 90-40 vol. % Al₂O₃. The formation of the first current conductor as an end cap (end wall) of the lamp vessel leads to a very compact lamp construction, while the metals molybdenum, tungsten, iridium, rhodium, and rhenium, or an alloy thereof, are halide-resistant. Furthermore, research has revealed that the volume percentages mentioned for the cermet layer of molybdenum and Al₂O₃ satisfies two mutually conflicting requirements: on the one hand the vol. % molybdenum should be as low as possible to enhance the adhesion in the area between the cermet layer and the lamp vessel, while on the other hand the vol. % molybdenum should be as high as possible to obtain an optimum adhesion between the cermet layer and the metal end cap. The use of the present cermet layer also leads to a significant increase in the fracture resistance of the lamp vessel by embedding any surface imperfections which are inadvertently introduced during previous manufacturing steps.

In one preferred embodiment of an electric lamp in accordance with the invention, said cermet layer comprises approximately 33⅓ vol. % molybdenum and approximately 66⅔ vol. % Al₂O₃. Alternatively, the cermet layer comprises a plurality of layers, and the vol. % of molybdenum increases stepwise from the inner layer to the outer layer. Particularly, the vol. % of molybdenum gradually increases from the inner layer (facing the lamp vessel) to the outer layer. The vol. % of Al₂O₃ decreases accordingly, as the cermet layer is a composite of molybdenum and Al₂O₃. An ideal situation is thus obtained, wherein the vol. % of molybdenum in the area between the cermet layer and the lamp vessel is relatively low (resulting in a strong adhesion in that location) and wherein the vol. % of molybdenum in the area between the cermet layer and the metal cap is relatively high (leading to an excellent sealing in that location).

In another preferred embodiment of an electric lamp according to the invention, a sealing braze is present between the end cap and the cermet layer. The sealing braze comprises a metal chosen from the group consisting of platinum, palladium, rhodium, and iridium. Possibly, the sealing braze also comprises one or more elements chosen from the group formed by Ni, B, Si, Ti, Zr, Y, and Nb.

U.S. Pat. No. 4,892,498 (Gradl et al.) describes a fluorescent lamp with a metal end cap and a lamp vessel sealed together by means of a braze. However, the metal cap and the braze material are not halide-resistant.

The invention will now be explained in more detail with reference to Figures illustrated in a drawing, wherein

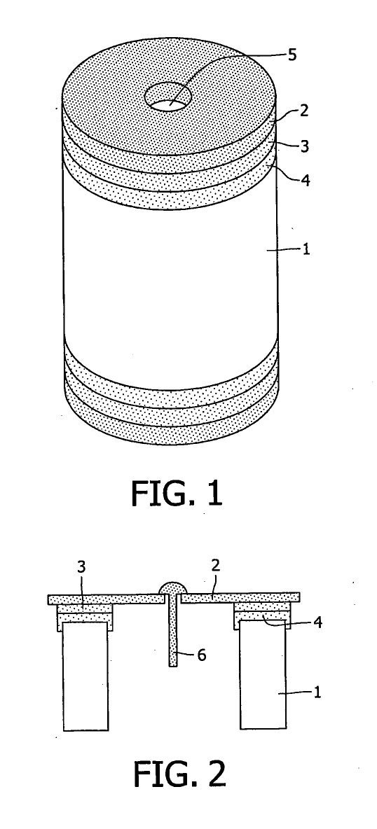

FIG. 1 is a schematic perspective view of a translucent ceramic lamp vessel of an electric discharge lamp in accordance with the invention, wherein said lamp vessel is provided with a metal cap, a cermet layer, and a cermet layer; and

FIG. 2 is a schematic cross-sectional view of one end of the lamp vessel of FIG. 1.

FIG. 1 schematically shows a tubular translucent ceramic lamp vessel 1 in accordance with a preferred embodiment of the invention, wherein a very compact lamp construction is realized. A metal cap 2 made of molybdenum is sealed onto said lamp vessel 1, where the lamp vessel is equipped with a cermet layer 4 comprised of approximately 33⅓ vol. % molybdenum and approximately 66⅔ vol. % Al₂O₃. A sealing braze 3 is present in-between. Filling of the lamp vessel 1 is performed through a central hole 5 in the metal cap 2, which is subsequently closed by the insertion of an electrode 6 (see FIG. 2) and a lead-out wire (not shown).

The end cap as depicted in FIG. 2 may be used at one end or both ends of the lamp vessel (see FIG. 1).

The invention is not restricted to the variants shown in the drawing, but it also extends to other embodiments that fall within the scope of the appended claims.

1. An electric discharge lamp comprising:
a translucent ceramic lamp vessel;
a first and a second current conductor, each supporting an electrode in the lamp vessel;
an ionizable filling comprising a rare gas and metal halide in the lamp vessel;
at least the first current conductor being halide-resistant,
characterized in that the first current conductor forms an end cap of the lamp vessel, wherein said end cap is made of a metal selected from the group consisting of molybdenum, tungsten, iridium, rhodium, and rhenium, or an alloy thereof, and wherein said end cap is sealed onto the lamp vessel where the lamp vessel is equipped with a cermet layer comprising 10-60 vol. % molybdenum and 90-40 vol. % Al₂O₃.

2. An electric discharge lamp according to claim 1, wherein said cermet layer comprises approximately 33⅓ vol. % molybdenum and approximately 66⅔ vol. % Al₂O₃.

3. An electric discharge lamp according to claim 1, wherein the cermet layer comprises a plurality of layers, and wherein the vol. % of molybdenum increases stepwise from the inner layer to the outer layer.

4. An electric discharge lamp according to claim 1, wherein the vol. % of molybdenum increases gradually from the inner layer to the outer layer.

5. An electric discharge lamp according to claim 1, wherein a sealing braze is present between the end cap and the cermet layer.

6. An electric discharge lamp according to claim 5, wherein the sealing braze comprises a metal chosen from the group consisting of platinum, palladium, rhodium, and iridium.

7. An electric discharge lamp according to claim 6, wherein the sealing braze also comprises one or more elements chosen from the group formed by Ni, B, Si, Ti, Zr, Y, and Nb.
